(19) United States
(12) Patent Application Publication
(10) Pub. No.: US 2025/0316051 A1
(43) Pub. Date: Oct. 9, 2025

(54) METHOD FOR BIT RATE ALLOCATION, APPARATUS, ELECTRONIC DEVICE, AND STORAGE MEDIUM

(71) Applicant: BEIJING BAIDU NETCOM SCIENCE TECHNOLOGY CO., LTD., Beijing (CN)

(72) Inventor: Ke LIN, Beijing (CN)

(73) Assignee: BEIJING BAIDU NETCOM SCIENCE TECHNOLOGY CO., LTD., Beijing (CN)

(21) Appl. No.: 19/241,825

(22) Filed: Jun. 18, 2025

(30) Foreign Application Priority Data
Oct. 31, 2024 (CN) 202411545379.4

(51) Int. Cl. G06V 10/25; G06V 10/28; G06V 10/46

(52) U.S. Cl. CPC G06V 10/25; G06V 10/28; G06V 10/462

(57) ABSTRACT

A method for bit rate allocation, an apparatus, an electronic device and a storage medium are disclosed, which relate to the field of artificial intelligence technology, such as computer vision, image processing and video encoder. The method for bit rate allocation includes: obtaining N region of interest (ROI) detection results of an image to be processed, wherein N is a positive integer greater than one, and the N ROI detection results comprise: detection results obtained by performing ROI detection on the image to be processed using N different detection operators respectively; generating a target block quantization parameter offset mask map corresponding to the image to be processed based on the N ROI detection results; performing a bit rate allocation on each image block in the image to be processed based on the target block quantization parameter offset mask map.

### CROSS-REFERENCE TO RELATED APPLICATION

The present application claims the priority and benefit of Chinese Patent Application No. 202411545379.4, filed on Oct. 31, 2024, entitled “METHOD FOR BIT RATE ALLOCATION, APPARATUS, ELECTRONIC DEVICE, AND STORAGE MEDIUM”. The disclosure of the above application is incorporated herein by reference in its entirety.

### TECHNICAL FIELD

The present disclosure relates to the field of artificial intelligence technology, in particular, to a method for bit rate allocation, an apparatus, an electronic device and a storage medium in the fields of computer vision, image processing and video encoder.

### BACKGROUND

Currently, video has become an indispensable part of people's lives, and people can conveniently watch various short videos, live broadcasts, movies or TV series through various applications (APPs). For video providers, how to improve the subjective quality of videos is an urgent problem to be solved.

### SUMMARY

The present disclosure provides a method for bit rate allocation, an apparatus, an electronic device and a storage medium.

A method for bit rate allocation includes obtaining N region of interest (ROI) detection results of an image to be processed, wherein N is a positive integer greater than one, and the N ROI detection results include: detection results obtained by performing ROI detection on the image to be processed using N different detection operators respectively; generating a target block quantization parameter offset mask map corresponding to the image to be processed based on the N ROI detection results; performing a bit rate allocation on each image block in the image to be processed based on the target block quantization parameter offset mask map.

An electronic device includes at least one processor; and a memory communicatively connected with the at least one processor; wherein the memory stores instructions executable by the at least one processor, and the instructions are executed by the at least one processor to enable the at least one processor to perform a method for bit rate allocation, wherein the method for bit rate allocation includes obtaining N region of interest (ROI) detection results of an image to be processed, wherein N is a positive integer greater than one, and the N ROI detection results include: detection results obtained by performing ROI detection on the image to be processed using N different detection operators respectively; generating a target block quantization parameter offset mask map corresponding to the image to be processed based on the N ROI detection results; performing a bit rate allocation on each image block in the image to be processed based on the target block quantization parameter offset mask map.

A non-transitory computer readable storage medium with computer instructions stored thereon, wherein the computer instructions are used for causing a method for bit rate allocation, wherein the method for bit rate allocation includes: obtaining N region of interest (ROI) detection results of an image to be processed, wherein N is a positive integer greater than one, and the N ROI detection results include: detection results obtained by performing ROI detection on the image to be processed using N different detection operators respectively; generating a target block quantization parameter offset mask map corresponding to the image to be processed based on the N ROI detection results; performing a bit rate allocation on each image block in the image to be processed based on the target block quantization parameter offset mask map.

It should be understood that the contents described in this section are not intended to identify key or essential features of the embodiments of the present disclosure, nor are they used to limit the scope of the present disclosure. Other features of the present disclosure will become readily understood through the following specification.

### BRIEF DESCRIPTION OF THE DRAWINGS

The drawings are used for better understanding the present solution and do not constitute a limitation of the present disclosure. In the drawings,

FIG. 1 is a flowchart of the method for bit rate allocation according to the first embodiment of the present disclosure;

FIG. 2 is a flowchart of the method for bit rate allocation according to the second embodiment of the present disclosure;

FIG. 3 is a schematic diagram of the overall implementation process of the method for bit rate allocation of the present disclosure;

FIG. 4 is a structural diagram of the apparatus 400 for bit rate allocation according to an embodiment of the present disclosure;

FIG. 5 shows a schematic block diagram of an electronic device 500 that can be used to implement embodiments of the present disclosure.

### DETAILED DESCRIPTION

The following makes a description of exemplary embodiments of the present disclosure in conjunction with the drawings, which includes various details of the embodiments of the present disclosure to aid in understanding, and should be considered merely as exemplary. Therefore, those skilled in the art should recognize that various changes and modifications can be made to the embodiments described herein without departing from the scope and spirit of the present disclosure. Similarly, for clarity and conciseness, description of known functions and structures is omitted in the following description.

Furthermore, it should be understood that the term “and/or” used in this document is merely a description of associative relationships between associated objects, indicating that three relationships may exist. For example, A and/or B may indicate: A exists alone, both A and B exist simultaneously, or B exists alone. Additionally, the character “/” used in this document generally indicates an “or” relationship between the associated objects before and after it.

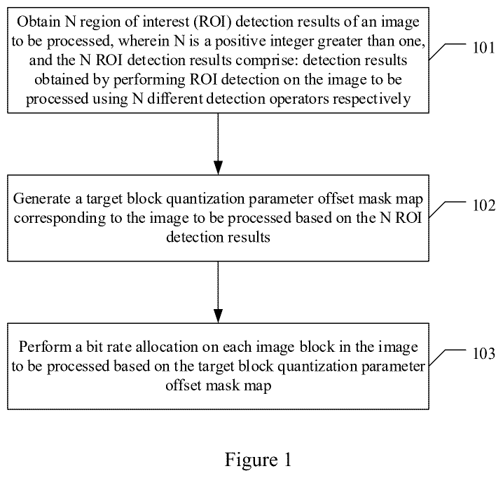

FIG. 1 is a flowchart of the method for bit rate allocation according to the first embodiment of the present disclosure. As shown in FIG. 1, the method includes:

In step 101, N region of interest (ROI) detection results of an image to be processed are obtained, where N is a positive integer greater than one. The N ROI detection results include: detection results obtained by performing ROI detection on the image to be processed using N different detection operators respectively.

In step 102, a target block quantization parameter (QP) offset mask map corresponding to the image to be processed is generated based on the N ROI detection results.

In step 103, a bit rate allocation is performed on each image block in the image to be processed based on the target block QP offset mask map.

By adopting the solution described in the above method embodiment, a target block QP offset mask map can be generated based on N ROI detection results of the image to be processed, and the bit rate allocation can be performed on each image block in the image to be processed based on the target block QP offset mask map. The image to be processed can be an original image in a video, or an image obtained after certain optimization processing of the original image in the video, thereby improving the rationality of bit rate allocation, enhancing image quality, and improving the subjective quality of video and the user viewing experience.

The specific value of N can be determined according to actual needs. N different detection operators can be used to perform ROI detection on the image to be processed respectively to obtain N ROI detection results. For example, commonly used detection operators may include face detection operators, human body detection operators, subtitle detection operators, saliency region detection operators, and contour detection operators, etc., and the corresponding ROI detection results can be: face boxes, human body boxes, subtitle boxes, saliency region mask maps, and contour points (i.e., contour pixel position set) respectively. In practical applications, the number of obtained ROI detection results can also be greater than N, and some of them, such as N results, can be processed according to the solution described in the present disclosure, while the remaining ROI detection results can be used for other processing.

The target block QP offset mask map corresponding to the image to be processed can be generated based on the N ROI detection results.

In some embodiments of the present disclosure, an initial block QP offset mask map can first be generated based on the image to be processed, then value optimization can be performed on the initial block QP offset mask map based on the N ROI detection results and QP offset values corresponding to the N ROI detection results respectively, and finally the target block QP offset mask map can be determined based on the result of value optimization.

In some embodiments of the present disclosure, the initial block QP offset mask map can have a size of M*N, where M is equal to the ratio of the length of the image to be processed to L, and N is equal to the ratio of the width of the image to be processed to L. Additionally, values of all pixel points in the initial block QP offset mask map can be 0, and each pixel point corresponds to an image block of L*L size in the image to be processed, with no overlap between any two image blocks.

For a frame of image, its bit rate allocation is based on blocks (image blocks), and bit rate allocation is implemented through QP. The larger the QP value, the lower the encoding bit rate; conversely, the smaller the QP value, the higher the encoding bit rate.

The size of a single image block (i.e., the value of L) can be determined according to actual needs, such as 16*16 size or 8*8 size, etc. The following description takes 16*16 size as an example. Correspondingly, both the length and width of the image to be processed need to be multiples of 16. If they are not multiples of 16, they can be adjusted through preprocessing. Assuming the image to be processed is 1600*1600 in size, it can be divided into 100*100 image blocks, in which case the initial block QP offset mask map also needs to be 100*100 in size.

The value of each pixel point in the initial block QP offset mask map is 0 (no QP adjustment), and each pixel point corresponds to an image block in the image to be processed. After obtaining the initial block QP offset mask map, value optimization can be further performed on the initial block QP offset mask map based on the N ROI detection results and QP offset values corresponding to the N ROI detection results respectively, and then the target block QP offset mask map can be determined based on the result of value optimization.

In other words, in the solution described in the present disclosure, various ROI detection results can correspond to their respective QP offset values, with specific values determined according to actual needs.

Furthermore, in traditional methods, typically only a single ROI region is processed, such as only a face is processed, or the face, body and subtitles are combined into one ROI region for processing, and then different bit rate allocation strategies are configured for the ROI region and the non-ROI region, which yields unsatisfactory results. In contrast, the solution described in the present disclosure can achieve bit rate allocation for multi-ROI region based on mask maps, thereby improving effects of the bit rate allocation and enhancing the subjective quality of video.

Additionally, whether it is the initial block QP offset mask map or the target block QP offset mask map, the value of each pixel point can be represented using 8-bit integer (int8_t).

For the initial block QP offset mask map, value optimization can be performed based on the N ROI detection results and the QP offset values corresponding to the N ROI detection results.

In some embodiments of the present disclosure, the method for value optimization may include: traversing the N ROI detection results sequentially in order from low to high according to the preset priority, and for each traversed ROI detection result, performing the following processing: taking the currently traversed ROI detection result as the detection result to be processed, determining the pixel points that match the detection result to be processed from the initial block QP offset mask map, and setting the value of the matching pixel points to the QP offset value corresponding to the detection result to be processed.

There is no restriction on the priority order of N ROI detection results. For example, if the N ROI detection results include: face box, human body box, subtitle box, saliency region mask map, and contour point, then the order from low to high priority could be: saliency region mask map, contour point, subtitle box, human body box, and face box.

Specifically, the ROI detection result with the lowest priority is first taken as the detection result to be processed, and the pixel points matching the detection result to be processed can be determined from the initial block QP offset mask map. Then, the values of matching pixel points are set to the QP offset value corresponding to the detection result to be processed (currently the lowest priority ROI detection result). Next, the ROI detection result with the second-lowest priority is taken as the detection result to be processed, and the pixel points matching the detection result to be processed are determined from the initial block QP offset mask map. Then, the value of matching pixel points is set to the QP offset value corresponding to the detection result to be processed (currently the second-lowest priority ROI detection result), and so on, until the above processing is completed for the highest priority ROI detection result, obtaining the value optimization result.

Since processing is done in order from low to high priority, higher priority value assignments will overwrite lower priority ones. Thus, even if a pixel point matches multiple ROI detection results, it will ultimately be assigned according to the highest priority ROI detection result, ensuring the accuracy of processing results.

Furthermore, In addition, different types of ROI detection results can be expressed in different forms, such as face box, human box, and subtitle box, which are all detection results in the form of rectangular boxes, contour points are contour pixel position sets, and significant region mask images are mask images with significant (represented by 1) and non-significant (represented by 0) marked in one frame. In traditional methods, when merging different types of ROI detection results into one ROI region, multiple processing steps are usually required, such as processing face boxes first, then subtitle boxes, contour points, and saliency region mask maps, followed by processing the entire image, and finally merging all processing results into one image, making the process very complex with high processing logic and computational complexity. Moreover, a pixel point may have multiple attributes, such as being both a face pixel and a contour point pixel, making merging very complicated. In contrast, the solution described in the present disclosure only needs to assign values according to the priority order of different types of ROI detection results to obtain the desired target result, making the entire process simple and convenient to implement, effectively simplifying processing logic, reducing computational complexity, and improving processing efficiency.

In the present embodiment, when determining the pixel points that match the detection result to be processed from the initial block QP offset mask map, different methods can be used for different types of ROI detection results to determine matching pixel points, mainly including the following methods: Method 1, Method 2, and Method 3.

### 1) Method 1

In response to determining that the detection result to be processed is a detection result in the form of rectangular boxes, the pixel points in the initial block QP offset mask map meeting the following requirement are determined as matching pixel points: the image block corresponding to the pixel overlaps with the rectangular box.

The detection results in rectangular box form may include: face boxes, human body boxes, and subtitle boxes, etc.

Taking face boxes as an example, assuming that an image block corresponding to a pixel point with coordinates (12, 15) in the initial block QP offset mask map is either entirely or partially within a face box, then this pixel point can be determined as a matching pixel point, and the value of the matching pixel point can be set as the QP offset value corresponding to the face box.

### 2) Method 2

In response to determining that the detection result to be processed is a saliency region mask map, pixel points in the initial block QP offset mask map meeting the following requirement are determined as matching pixel points: the proportion of first type pixel points in the total number of pixel points in the image block corresponding to the pixel is greater than a first threshold, where first type pixel points are pixel points with value 1 in the saliency region mask map. The saliency region mask map has the same size as the image to be processed, and each pixel point in the saliency region mask map has a value of either 1 or 0 respectively.

The specific value of the first threshold can be determined according to actual needs, such as 50%. Assume that the image block x corresponds to a pixel point with coordinates (2, 4) in the initial block QP offset mask map, the total number of pixel points in image block x is 16*16=256, and the number of pixel points with value 1 in the saliency region mask map is 180. Since 180 accounts for about 70% of 256, which is greater than the first threshold, this pixel point can be determined as a matching pixel point, and the value of the matching pixel point can be set to the QP offset value corresponding to the saliency region mask map.

### 3) Method 3

In response to determining that the detection result to be processed is contour points, the pixel points in the initial block QP offset mask map meeting the following requirement are determined as matching pixel points: the proportion of second type pixel points in the total number of pixel points in the image block corresponding to the pixel point is greater than a second threshold, where second type pixel points are pixel points belonging to contour points.

The specific value of the second threshold can be determined according to actual needs, such as 10%. Assume that the image block y corresponds to a pixel point with coordinates (10, 10) in the initial block QP offset mask map, the total number of pixel points in image block y is 16*16=256, and the number of pixel points belonging to contour points is 50. Since 50 accounts for about 20% of 256, which is greater than the second threshold, this pixel point can be determined as a matching pixel point, and its value can be set to the QP offset value corresponding to contour points.

As can be seen, in the above processing methods, different approaches can be used for different types of ROI detection results to determine matching pixel points from the initial block QP offset mask map, thereby improving the accuracy of determination results and consequently improving the accuracy of value optimization results.

Based on the value optimization result, the target block QP offset mask map can be determined. In some embodiments of the present disclosure, the value optimization result can be directly determined as the target block QP offset mask map, or the value optimization result can be determined as an intermediate block QP offset mask map, and then the average value of all pixel values in the intermediate block QP offset mask map can be obtained. Subsequently, this average value can be added to the values of all pixel points in the intermediate block QP offset mask map to obtain the target block QP offset mask map.

In other words, after performing value optimization on the initial block QP offset mask map, the optimization result can be directly determined as the target block QP offset mask map, or further optimization can be performed based on the optimization result. For ease of description, the value optimization result is called the intermediate block QP offset mask map. The average value of all pixel values in the intermediate block QP offset mask map can be obtained, assumed to be avg_deltaQP (usually a negative number), and then avg_deltaQP can be added to the values of all pixel points in the intermediate block QP offset mask map to obtain the desired target block QP offset mask map.

The specific method to be adopted can be determined according to actual needs, making it very flexible and convenient. However, preferably, the latter method can be adopted. By using this method, the sum of offset values for all image blocks can be made zero, avoiding significant impact on the overall bit rate. From an implementation perspective, it only allocates some additional bit rate to ROI regions to improve the perceptual quality of images and videos for human eyes, while correspondingly reducing some bit rate for non-ROI regions, thereby maintaining the overall bit rate as constant as possible and reducing resource consumption.

Furthermore, the bit rate allocation can be performed on each image block in the image to be processed based on the obtained target block QP offset mask map.

In some embodiments of the present disclosure, for any image block in the image to be processed, the following processing can be performed respectively: obtaining the initial block QP determined by the Adaptive Quantization (AQ) algorithm for that image block, and adding the value of the corresponding pixel in the target block QP offset mask map to the initial block QP to obtain the bit rate allocation result for that image block.

According to the traditional AQ algorithm, initial block QP can be obtained for each image block respectively. Based on this, the solution described in the present disclosure adds extra offset values for each image block according to the target block QP offset mask map, thereby implementing a bit rate allocation strategy for multiple ROI regions. While maintaining the overall bit rate as constant as possible, more bit rate is allocated to ROI regions that attract human attention, thereby improving the quality of images and videos.

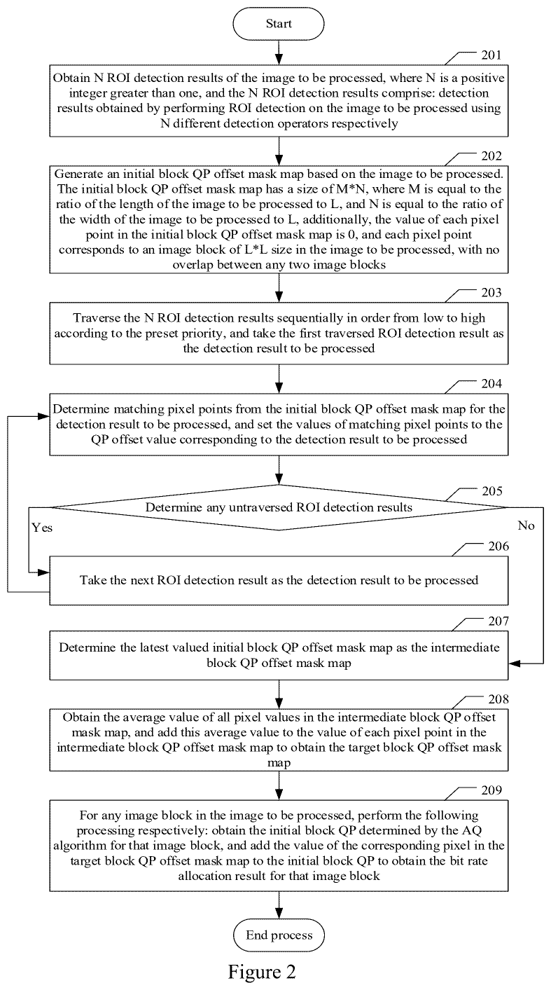

Based on the above introduction, FIG. 2 is a flowchart of the method for bit rate allocation according to the second embodiment of the present disclosure. As shown in FIG. 2, the method includes:

Step 201: Obtain N ROI detection results of the image to be processed, where N is a positive integer greater than one, and the N ROI detection results include: detection results obtained by performing ROI detection on the image to be processed using N different detection operators respectively.

Step 202: Generate an initial block QP offset mask map based on the image to be processed. The initial block QP offset mask map has a size of M*N, where M is equal to the ratio of the length of the image to be processed to L, and N is equal to the ratio of the width of the image to be processed to L, additionally, the value of each pixel point in the initial block QP offset mask map is 0, and each pixel point corresponds to an image block of L*L size in the image to be processed, with no overlap between any two image blocks.

Step 203: Traverse the N ROI detection results sequentially in order from low to high according to the preset priority, and take the first traversed ROI detection result as the detection result to be processed.

Step 204: Determine matching pixel points from the initial block QP offset mask map for the detection result to be processed, and set the values of matching pixel points to the QP offset value corresponding to the detection result to be processed.

Step 205: Determine whether there are any untraversed ROI detection results. If yes, execute Step 206; if no, execute Step 207.

Step 206: Take the next ROI detection result as the detection result to be processed, then repeat Step 204.

Step 207: Determine the latest valued initial block QP offset mask map as the intermediate block QP offset mask map.

Step 208: Obtain the average value of all pixel values in the intermediate block QP offset mask map, and add this average value to the value of each pixel point in the intermediate block QP offset mask map to obtain the target block QP offset mask map.

Step 209: For any image block in the image to be processed, perform the following processing respectively: obtain the initial block QP determined by the AQ algorithm for that image block, and add the value of the corresponding pixel in the target block QP offset mask map to the initial block QP to obtain the bit rate allocation result for that image block, then end the process.

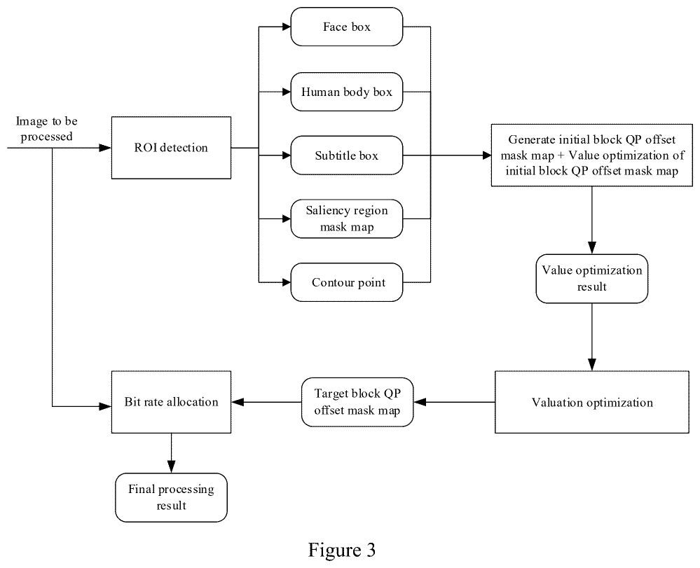

FIG. 3 illustrates the overall implementation process of the method for bit rate allocation described in the present disclosure. As shown in FIG. 3, for the image to be processed, N different detection operators can be used respectively to perform ROI detection, obtaining N ROI detection results, which may include: face boxes, human body boxes, subtitle boxes, saliency region mask maps, and contour points. As shown in FIG. 3, an initial block QP offset mask map is then generated and undergoes value optimization. The initial block QP offset mask map has a size of M*N, where M is equal to the ratio of the length of the image to be processed to L, and N is equal to the ratio of the width of the image to be processed to L. Additionally, the value of each pixel point in the initial block QP offset mask map can be 0, and each pixel point corresponds to an image block of L*L size in the image to be processed, with no overlap between any two image blocks. Value optimization is performed on the initial block QP offset mask map based on the N ROI detection results and their corresponding QP offset values. This can be done by traversing the N ROI detection results sequentially in order from low to high according to the preset priority. For each traversed ROI detection result, the following processing is performed: taking the currently traversed ROI detection result as the detection result to be processed, determining matching pixel points from the initial block QP offset mask map, and setting the values of matching pixel points to the QP offset value corresponding to the detection result to be processed. As shown in FIG. 3, further valuation optimization can be performed on the obtained value optimization result. The optimization result can be taken as an intermediate block QP offset mask map, and the average value of all pixel values in the intermediate block QP offset mask map can be obtained. This average value is then added to the values of all pixel points in the intermediate block QP offset mask map to obtain the target block QP offset mask map. As shown in FIG. 3, the bit rate allocation can then be performed on each image block in the image to be processed based on the target block QP offset mask map to obtain the final processing result. For any image block in the image to be processed, the following processing is performed: obtaining the initial block QP determined by the AQ algorithm for that image block, and adding the value of the corresponding pixel point in the target block QP offset mask map to the initial block QP to obtain the bit rate allocation result for that image block.

It should be noted that for the preceding method embodiments, for simple description, they are all expressed as a series of action combinations. However, those skilled in the art should know that the present disclosure is not limited by the described action sequence, as according to the present disclosure, some steps can be performed in other orders or simultaneously. Secondly, those skilled in the art should also know that the embodiments described in the specification are all preferred embodiments, and the actions and modules involved are not necessarily essential to the present disclosure. Additionally, for parts not detailed in one embodiment, reference can be made to relevant descriptions in other embodiments.

The above is an introduction to the method embodiments. The following further explains the solution described in the present disclosure through embodiments of apparatus.

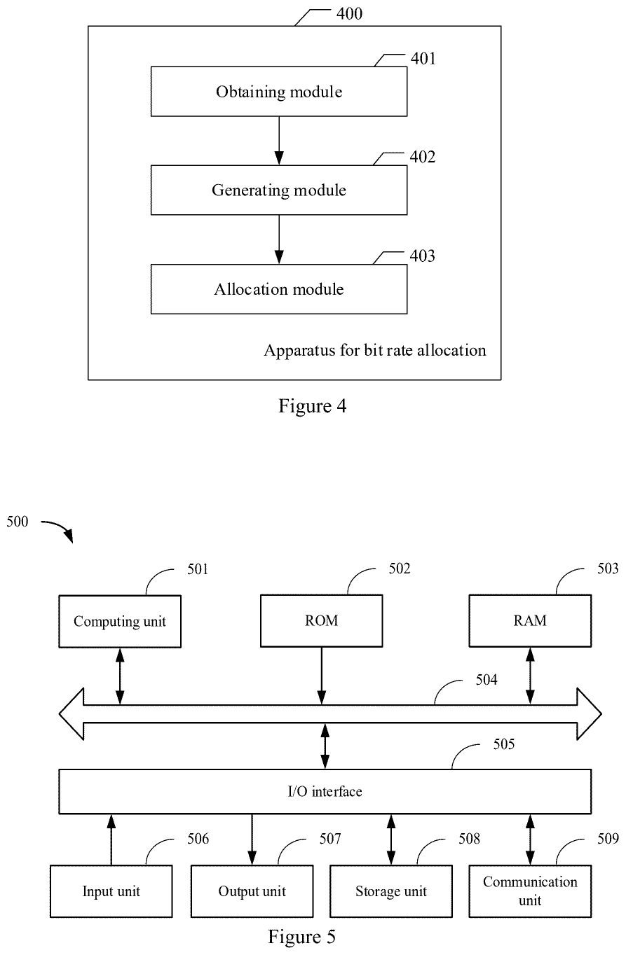

FIG. 4 is a structural diagram of the apparatus 400 for bit rate allocation according to an embodiment of the present disclosure. As shown in FIG. 4, it includes: obtaining module 401, generating module 402, and allocation module 403.

The obtaining module 401 is configured to obtain N ROI detection results of the image to be processed, where N is a positive integer greater than one, and the N ROI detection results include: detection results obtained by performing ROI detection on the image to be processed using N different detection operators respectively.

The generating module 402 is configured to generate a target block QP offset mask map corresponding to the image to be processed based on the N ROI detection results.

The allocation module 403 is configured to perform the bit rate allocation on each image block in the image to be processed based on the target block QP offset mask map.

By adopting the solution described in the above apparatus embodiment, a target block QP offset mask map can be generated based on N ROI detection results of the image to be processed, and bit rate allocation can be performed on each image block in the image to be processed based on the target block QP offset mask map. The image to be processed can be an original image in a video, or an image obtained after certain optimization processing of the original image in the video, thereby improving the rationality of bit rate allocation, enhancing image quality, and improving the subjective quality of video and the user viewing experience.

N different detection operators can be used to perform ROI detection on the image to be processed respectively, obtaining N ROI detection results. For example, commonly used detection operators may include face detection operators, human body detection operators, subtitle detection operators, saliency region detection operators, and contour detection operators, with corresponding ROI detection results being: face boxes, human body boxes, subtitle boxes, saliency region mask maps, and contour points respectively.

Based on the N ROI detection results, generating module 402 can generate a target block QP offset mask map corresponding to the image to be processed.

In some embodiments of the present disclosure, the generating module 402 can first generate an initial block QP offset mask map based on the image to be processed, then perform value optimization on the initial block QP offset mask map based on the N ROI detection results and their corresponding QP offset values, and then determine the target block QP offset mask map based on the value optimization result.

In some embodiments of the present disclosure, the initial block QP offset mask map can have a size of M*N, where M is equal to the ratio of the length of the image to be processed to L, and N is equal to the ratio of the width of the image to be processed to L. Additionally, values of all pixel points in the initial block QP offset mask map are 0, and each pixel point corresponds to an image block of L*L size in the image to be processed, with no overlap between any two image blocks.

In some embodiments of the present disclosure, the generating module 402 can perform the value optimization in a method including: traversing the N ROI detection results sequentially in order from low to high according to the preset priority, and for each traversed ROI detection result, performing the following processing: taking the currently traversed ROI detection result as the detection result to be processed, determining pixel points that match the detection result to be processed from the initial block QP offset mask map, and setting the values of matching pixel points to the QP offset value corresponding to the detection result to be processed.

In the present embodiment, when determining matching pixel points from the initial block QP offset mask map, different methods can be used for different types of ROI detection results to determine matching pixel points.

In some embodiments of the present disclosure, in response to determining that the detection result to be processed is in the form of rectangular boxes, generating module 402 can determine pixel points meeting the following requirement in the initial block QP offset mask map as matching pixel points: the image block corresponding to the pixel overlaps with the rectangular box.

In some embodiments of the present disclosure, in response to determining that the detection result to be processed is a saliency region mask map, generating module 402 can determine pixel points meeting the following requirement in the initial block QP offset mask map as matching pixel points: the proportion of first type pixel points in the total number of pixel points in the image block corresponding to the pixel is greater than a first threshold, where first type pixel points are pixel points with value 1 in the saliency region mask map. The saliency region mask map has the same size as the image to be processed, and each pixel point in the saliency region mask map has a value of either 1 or 0.

In some embodiments of the present disclosure, in response to determining that the detection result to be processed is contour points, generating module 402 can determine pixel points meeting the following requirement in the initial block QP offset mask map as matching pixel points: the proportion of the number of second type pixel points in the total number of pixel points in the image block corresponding to the pixel is greater than a second threshold, where second type pixel points are pixel points belonging to contour points.

Based on the value optimization result, the target block QP offset mask map can be determined. In some embodiments of the present disclosure, the generating module 402 can directly determine the value optimization result as the target block QP offset mask map, or the generating module 402 can determine the value optimization result as an intermediate block QP offset mask map, obtain the average value of the values of each pixel point in the intermediate block QP offset mask map, and then add the average value to the values of each pixel point in the intermediate block QP offset mask map to obtain the target block QP offset mask map.

Furthermore, allocation module 403 can perform the bit rate allocation on each image block in the image to be processed based on the obtained target block QP offset mask map.

In some embodiments of the present disclosure, the allocation module 403, for any image block in the image to be processed, performs the following processing respectively: obtains the initial block QP determined by the AQ algorithm for that image block, and adds the value of the corresponding pixel in the target block QP offset mask map to the initial block QP to obtain the bit rate allocation result for that image block.

The specific workflow of the apparatus embodiment shown in FIG. 4 can refer to the relevant descriptions in the previous method embodiments and will not be repeated here.

The solution described in the present disclosure can be applied in the field of artificial intelligence, particularly in the fields of computer vision, image processing, and video encoders. Artificial intelligence is a discipline that studies how to simulate certain human thinking processes and intelligent behaviors (such as learning, reasoning, thinking, planning, etc.) using computers. It involves both hardware and software technologies. Artificial intelligence hardware technology generally includes technologies such as sensors, specialized AI chips, cloud computing, distributed storage, big data processing, etc. Artificial intelligence software technology mainly includes several major directions such as computer vision technology, speech recognition technology, natural language processing technology, machine learning/deep learning, big data processing technology, and knowledge graph technology.

The images and ROI detection results mentioned in the embodiments of the present disclosure are not targeted at any specific user and cannot reflect personal information of any specific user. In the technical solution of the present disclosure, the collection, storage, use, processing, transmission, provision, and disclosure of user personal information involved comply with relevant laws and regulations and do not violate public order and good morals.

According to the embodiments of the present disclosure, the present disclosure also provides an electronic device, a readable storage medium, and a computer program product.

FIG. 5 shows a schematic block diagram of an electronic device 500 that can be used to implement embodiments of the present disclosure. The electronic device is intended to represent various forms of digital computers, such as laptops, desktop computers, workstations, servers, blade servers, mainframes, and other suitable computers. The electronic device can also represent various forms of mobile devices, such as personal digital assistants, cellular phones, smartphones, wearable devices, and other similar computing devices. The components shown here, their connections and relationships, and their functions are meant merely as examples and are not intended to limit implementations of the disclosure described and/or claimed in this document.

As shown in FIG. 5, device 500 includes a computing unit 501, which can execute various appropriate actions and processing according to computer programs stored in Read-Only Memory (ROM) 502 or computer programs loaded from storage unit 508 to Random Access Memory (RAM) 503. Various programs and data required for device 500 operation can also be stored in RAM 503. Computing unit 501, ROM 502, and RAM 503 are connected to each other via bus 504. Input/Output (I/O) interface 505 is also connected to bus 504.

Multiple components in device 500 are connected to I/O interface 505, including: input unit 506, such as keyboard, mouse, etc.; output unit 507, such as various types of displays, speakers, etc.; storage unit 508, such as magnetic disks, optical disks, etc.; and communication unit 509, such as network cards, modems, wireless communication transceivers, etc. Communication unit 509 allows device 500 to exchange information/data with other devices through computer networks such as the Internet and/or various telecommunications networks.

Computing unit 501 can be various general and/or specialized processing components with processing and computing capabilities. Some examples of computing unit 501 include but are not limited to Central Processing Units (CPU), Graphics Processing Units (GPU), various specialized Artificial Intelligence (AI) computing chips, various computing units running machine learning model algorithms, Digital Signal Processors (DSP), and any appropriate processors, controllers, microcontrollers, etc. Computing unit 501 executes the various methods and processes described above, such as the methods described in the present disclosure. For example, in some embodiments, the methods described in the present disclosure can be implemented as computer software programs that are tangibly embodied in machine-readable media, such as storage unit 508. In some embodiments, part or all of the computer program can be loaded and/or installed onto device 500 via ROM 502 and/or communication unit 509. When the computer program is loaded into RAM 503 and executed by computing unit 501, it can execute one or more steps of the methods described in the present disclosure. Alternatively, in other embodiments, computing unit 501 can be configured to execute the methods described in the present disclosure through any other appropriate means (for example, through firmware).

Various implementations of the systems and techniques described in this document can be realized in digital electronic circuitry, integrated circuitry, Field Programmable Gate Arrays (FPGA), Application Specific Integrated Circuits (ASIC), Application Specific Standard Parts (ASSP), System on Chip (SOC), Complex Programmable Logic Devices (CPLD), computer hardware, firmware, software, and/or combinations of them. These various implementations can include: implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

Program code for implementing the methods of the present disclosure can be written in any combination of one or more programming languages. These program codes can be provided to processors or controllers of general-purpose computers, special-purpose computers, or other programmable data processing apparatus, such that the program codes, when executed by the processor or controller, implement the functions/operations specified in the flowcharts and/or block diagrams. The program code can execute entirely on the machine, partly on the machine, partly on the machine as a standalone software package and partly on a remote machine, or entirely on the remote machine or server.

In the context of the present disclosure, a machine-readable medium can be a tangible medium that can contain or store a program for use by or in connection with an instruction execution system, apparatus, or device. The machine-readable medium can be either a machine-readable signal medium or a machine-readable storage medium. The machine-readable medium can include, but is not limited to, electronic, magnetic, optical, electromagnetic, infrared, or semiconductor systems, apparatus, or devices, or any suitable combination thereof. More specific examples of machine-readable storage media would include an electrical connection based on one or more wires, a portable computer diskette, a hard disk, random access memory (RAM), read-only memory (ROM), Electronically Programmable Read-Only Memory (EPROM), flash memory, fiber optics, Compact Disc Read-Only Memory (CD-ROM), optical storage devices, magnetic storage devices, or any suitable combination thereof.

To provide interaction with a user, the systems and techniques described here can be implemented on a computer having a display device (e.g., a Cathode Ray Tube (CRT) or Liquid Crystal Display (LCD) monitor) for displaying information to the user, and a keyboard and pointing device (e.g., a mouse or trackball) by which the user can provide input to the computer. Other kinds of devices can be used to provide interaction with users; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or a middleware component (e.g., an application server), or a front-end component (e.g., a user computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include Local Area Networks (LAN), Wide Area Networks (WAN), and the Internet.

The computer system can include clients and servers. A client and server are generally remote from each other and typically interact through a communication network. The relationship between client and server arises by virtue of computer programs running on the respective computers and having a client-server relationship to each other. The server can be a cloud server, a server in a distributed system, or a server integrated with blockchain technology.

It should be understood that the various forms of processes shown above can be used, with steps re-ordered, added, or removed. For example, the steps recorded in the present disclosure can be executed in parallel or in sequence or in different orders, as long as they can achieve the desired results of the technical solutions disclosed in the present disclosure, which is not limited herein.

The above specific implementations do not constitute limitations on the scope of protection of the present disclosure. Those skilled in the art should understand that various modifications, combinations, sub-combinations and substitutions can be made according to design requirements and other factors. Any modifications, equivalent substitutions and improvements made within the spirit and principles of the present disclosure should be included within the scope of protection of the present disclosure.

What is claimed is:

1. A method for bit rate allocation, comprising:
obtaining N region of interest (ROI) detection results of an image to be processed, wherein N is a positive integer greater than one, and the N ROI detection results comprise: detection results obtained by performing ROI detection on the image to be processed using N different detection operators respectively;
generating a target block quantization parameter offset mask map corresponding to the image to be processed based on the N ROI detection results;
performing a bit rate allocation on each image block in the image to be processed based on the target block quantization parameter offset mask map.

2. The method according to claim 1, wherein the generating the target block quantization parameter offset mask map corresponding to the image to be processed comprises:
generating an initial block quantization parameter offset mask map based on the image to be processed;
performing a value optimization on the initial block quantization parameter offset mask map based on the N ROI detection results and quantization parameter offset values corresponding to the N ROI detection results respectively, and determining the target block quantization parameter offset mask map based on a result of the value optimization.

3. The method according to claim 2, wherein
the initial block quantization parameter offset mask map has a size of M*N, wherein M is equal to a ratio of a length of the image to be processed to L, and N is equal to a ratio of a width of the image to be processed to L; and
a value of each pixel point in the initial block quantization parameter offset mask map is 0, and each pixel point corresponds to an image block of L*L size in the image to be processed, with no overlap between any two image blocks.

4. The method according to claim 3, wherein the performing the value optimization on the initial block quantization parameter offset mask map comprises:
traversing the N ROI detection results sequentially in an order from low to high according to the preset priority, and for each traversed ROI detection result, performing the following processing:
taking a currently traversed ROI detection result as a detection result to be processed, determining pixel points that match the detection result to be processed from the initial block quantization parameter offset mask map, and setting values of the matching pixel points to a quantization parameter offset value corresponding to the detection result to be processed.

5. The method according to claim 4, wherein
in response to determining that the detection result to be processed is a detection result in a form of rectangular box, the determining the pixel points that match the detection result to be processed from the initial block quantization parameter offset mask map comprises:
determining pixel points meeting the following requirement in the initial block quantization parameter offset mask map as the matching pixel points: an image block corresponding to the pixel overlaps with the rectangular box.

6. The method according to claim 4, wherein
in response to determining that the detection result to be processed is a saliency region mask map, the determining the pixel points that match the detection result to be processed from the initial block quantization parameter offset mask map comprises:
determining pixel points meeting the following requirement in the initial block quantization parameter offset mask map as the matching pixel points: a proportion of a number of first type pixel points in a total number of pixel points in an image block corresponding to the pixel is greater than a first threshold, wherein the first type pixel points are pixel points with a value of 1 in the saliency region mask map, the saliency region mask map has a same size as the image to be processed, and each pixel point in the saliency region mask map has a value of either 1 or 0 respectively.

7. The method according to claim 4, wherein
in response to determining that the detection result to be processed is contour points, the determining the pixel points that match the detection result to be processed from the initial block quantization parameter offset mask map comprises:
determining pixel points meeting the following requirement in the initial block quantization parameter offset mask map as the matching pixel points: a proportion of a number of second type pixel points in a total number of pixel points in an image block corresponding to the pixel is greater than a second threshold, wherein the second type pixel points are pixel points belonging to the contour points.

8. The method according to claim 3, wherein determining the target block quantization parameter offset mask map based on the result of the value optimization comprises:
determining the result of the value optimization as the target block quantization parameter offset mask map; or
determining the result of the value optimization as an intermediate block quantization parameter offset mask map, obtaining an average value of values of each pixel points in the intermediate block quantization parameter offset mask map, and adding the average value to values of each pixel point in the intermediate block quantization parameter offset mask map to obtain the target block quantization parameter offset mask map.

9. The method according to claim 3, wherein the performing the bit rate allocation on each image block in the image to be processed comprises:
for any image block in the image to be processed, performing the following processing: obtaining an initial block quantization parameter of the image block determined according to an adaptive quantization algorithm, and adding a value of a corresponding pixel in the target block quantization parameter offset mask map to the initial block quantization parameter to obtain a bit rate allocation result of the image block.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method for bit rate allocation, wherein the method for bit rate allocation comprises:
obtaining N region of interest (ROI) detection results of an image to be processed, wherein N is a positive integer greater than one, and the N ROI detection results comprise:
detection results obtained by performing ROI detection on the image to be processed using N different detection operators respectively;
generating a target block quantization parameter offset mask map corresponding to the image to be processed based on the N ROI detection results;
performing a bit rate allocation on each image block in the image to be processed based on the target block quantization parameter offset mask map.

11. The electronic device according to claim 10, wherein the generating the target block quantization parameter offset mask map corresponding to the image to be processed comprises:
generating an initial block quantization parameter offset mask map based on the image to be processed, and
performing value optimization on the initial block quantization parameter offset mask map based on the N ROI detection results and quantization parameter offset values corresponding to the N ROI detection results respectively, and determining the target block quantization parameter offset mask map based on a result of the value optimization.

12. The electronic device according to claim 11, wherein
the initial block quantization parameter offset mask map has a size of M*N, wherein M is equal to a ratio of a length of the image to be processed to L, and N is equal to a ratio of a width of the image to be processed to L; and
a value of each pixel points in the initial block quantization parameter offset mask map is 0, and each pixel point corresponds to an image block of L*L size in the image to be processed, with no overlap between any two image blocks.

13. The electronic device according to claim 12, wherein the performing the value optimization on the initial block quantization parameter offset mask map comprises:
traversing the N ROI detection results sequentially in an order from low to high according to the preset priority, and for each traversed ROI detection result, performing the following processing: taking a currently traversed ROI detection result as a detection result to be processed, determining pixel points that match the detection result to be processed from the initial block quantization parameter offset mask map, and setting values of the matching pixel points to a quantization parameter offset value corresponding to the detection result to be processed.

14. The electronic device according to claim 13, wherein
in response to determining that the detection result to be processed is a detection result in a form of rectangular box, the determining the pixel points that match the detection result to be processed from the initial block quantization parameter offset mask map comprises:
determining pixel points meeting the following requirement in the initial block quantization parameter offset mask map as the matching pixel points: an image block corresponding to the pixel overlaps with the rectangular box.

15. The electronic device according to claim 13, wherein
in response to determining that the detection result to be processed is a saliency region mask map, the determining the pixel points that match the detection result to be processed from the initial block quantization parameter offset mask map comprises:
determining pixel points meeting the following requirement in the initial block quantization parameter offset mask map as the matching pixel points: a proportion of a number of first type pixel points in a total number of pixel points in an image block corresponding to the pixel is greater than a first threshold, wherein the first type pixel points are pixel points with a value of 1 in the saliency region mask map, the saliency region mask map has a same size as the image to be processed, and each pixel point in the saliency region mask map has a value of either 1 or 0 respectively.

16. The electronic device according to claim 13, wherein
in response to determining that the detection result to be processed is contour points, the determining the pixel points that match the detection result to be processed from the initial block quantization parameter offset mask map comprises:
determining pixel points meeting the following requirement in the initial block quantization parameter offset mask map as the matching pixel points: a proportion of a number of second type pixel points in a total number of pixel points in an image block corresponding to the pixel is greater than a second threshold, wherein the second type pixel points are pixel points belonging to the contour points.

17. The electronic device according to claim 12, wherein determining the target block quantization parameter offset mask map based on the result of the value optimization comprises:
determining the result of the value optimization as the target block quantization parameter offset mask map, or
determining the result of the value optimization as an intermediate block quantization parameter offset mask map, obtaining an average value of values of each pixel points in the intermediate block quantization parameter offset mask map, and adding the average value to values of each pixel points in the intermediate block quantization parameter offset mask map to obtain the target block quantization parameter offset mask map.

18. The electronic device according to any claim 12, wherein the performing the bit rate allocation on each image block in the image to be processed comprises:
for any image block in the image to be processed, performing the following processing: obtaining an initial block quantization parameter of the image block determined according to an adaptive quantization algorithm, and adding a value of a corresponding pixel in the target block quantization parameter offset mask map to the initial block quantization parameter to obtain a bit rate allocation result of the image block.

19. A non-transitory computer readable storage medium with computer instructions stored thereon, wherein the computer instructions are used for causing a method for bit rate allocation, wherein the method for bit rate allocation comprises:
obtaining N region of interest (ROI) detection results of an image to be processed, wherein N is a positive integer greater than one, and the N ROI detection results comprise: detection results obtained by performing ROI detection on the image to be processed using N different detection operators respectively;
generating a target block quantization parameter offset mask map corresponding to the image to be processed based on the N ROI detection results;
performing a bit rate allocation on each image block in the image to be processed based on the target block quantization parameter offset mask map.

20. The non-transitory computer readable storage medium according to claim 19, wherein the generating the target block quantization parameter offset mask map corresponding to the image to be processed comprises:
generating an initial block quantization parameter offset mask map based on the image to be processed;
performing a value optimization on the initial block quantization parameter offset mask map based on the N ROI detection results and quantization parameter offset values corresponding to the N ROI detection results respectively, and determining the target block quantization parameter offset mask map based on a result of the value optimization.
